(19) United States
(12) Patent Application Publication
(10) Pub. No.: US 2020/0183748 A1
(43) Pub. Date: Jun. 11, 2020

(54) METHODS AND SYSTEMS THAT GENERATE OPTIMAL OR NEAR-OPTIMAL MATCHING OF RESOURCES TO RESOURCE USERS BY EMPLOYING RESOURCE-EXCHANGE OPTIMIZATION TOOLS

(71) Applicants: Vivek Bhatnagar, Seattle, WA (US); Vladimir Brayman, Mercer Island, WA (US)

(72) Inventors: Vivek Bhatnagar, Seattle, WA (US); Vladimir Brayman, Mercer Island, WA (US)

(21) Appl. No.: 16/215,390

(22) Filed: Dec. 10, 2018

(51) Int. Cl. G06F 9/50; G06Q 10/06

(52) U.S. Cl. CPC G06F 9/5011; G06Q 10/06313

(57) ABSTRACT

The current document is directed to methods and systems that provide optimal or near-optimal resource-exchange operation through configuration and control of resource exchanges. These methods and systems employ a number of currently disclosed optimization tools, including dimensional reduction of attribute vectors corresponding to resource-exchange entities, scoring resources with respect to their ease or likelihood of matching to resource users, and providing optimal or near-optimal attribute values for attribute vectors corresponding to resource-exchange entities. These optimization tools facilitate development of a wide variety of different types of resource-exchange-operation-improvement and resource-exchange-optimization methods and systems, including methods and systems for configuring resource exchanges to improve and/or optimize their operational behaviors.

### CROSS-REFERENCE TO RELATED APPLICATION

This application claims the benefit of Provisional Application No. 62/596,698, filed Dec. 8, 2017.

### TECHNICAL FIELD

The current document is directed to various types of automated and semi-automated resource exchanges in which resources are matched to resource users and, in particular, to methods for configuring and controlling a resource exchange in order to optimize or to nearly optimize matching of a particular set of resources to users.

### BACKGROUND

There are different types of automated and semi-automated systems that seek to match resources with resource users. Examples include various types of computational-resource distribution systems in which the computational resources of a data center or an aggregate system that includes multiple data centers are made available to computational-resource consumers. In general, information about available computational resources is distributed to potential users, who participate in a computational-resource exchange to lease one or more computational resources for various periods of time at various different prices. Additional types of resource exchanges include various types of automated and semi-automated markets in which users bid for resources, such as real-estate properties, goods, and services. Certain resource exchanges employ financial transactions as a basis for matching resources to resource users and for distributing resources to users, but many other types of resource exchanges may employ non-financial methods and metrics, including non-financial-based attribute matching and non-financial-based selection of resources by users. In many cases, designers, owners, and managers of automated and semi-automated resource-exchange systems seek to optimize operation of the resource exchange that they design, own, or manage. However, because of the great number of variables generally involved, optimizing the operation of a resource exchange is, at best, non-trivial and difficult and, at worst, intractable. As a result, those who design and develop, own, manage, and use resource exchanges continue to seek methods and system designs that produce better, near-optimal, or optimal resource-exchange operation.

### SUMMARY

The current document is directed to methods and systems that provide optimal or near-optimal resource-exchange operation through configuration and control of resource exchanges. These methods and systems employ a number of currently disclosed optimization tools, including dimensional reduction of attribute vectors corresponding to resource-exchange entities, scoring resources with respect to their ease or likelihood of matching to resource users, and providing optimal or near-optimal attribute values for attribute vectors corresponding to resource-exchange entities. These optimization tools facilitate development of a wide variety of different types of resource-exchange-operation-improvement and resource-exchange-optimization methods and systems, including methods and systems for configuring resource exchanges to improve and/or optimize their operational behaviors.

### BRIEF DESCRIPTION OF THE DRAWINGS

FIG. 1 provides a general architectural diagram for various types of computers.

FIG. 2 illustrates cloud computing.

FIG. 3 illustrates generalized hardware and software components of a general-purpose computer system, such as a general-purpose computer system having an architecture similar to that shown in FIG. 1.

FIG. 4 illustrates one type of virtual machine and virtual-machine execution environment.

FIG. 5 illustrates a resource exchange.

FIG. 6 illustrates additional aspects of the resource exchange discussed above with reference to FIG. 5.

FIG. 7 illustrates the problem of optimally configuring and controlling a resource exchange.

FIG. 8 illustrates various types of approaches that are used to decrease the number of variables in high-dimensional optimization problems.

FIG. 9 illustrates generation of a weight-of-evidence value (“WOE”) and an information value (“IV”).

FIGS. 10A-B illustrate generation of estimated WOE and IV values for two attributes from historical data.

FIG. 11 illustrates IV-based dimensional reduction and generation of a model μ for the outcome of a resource-exchange system based on the attribute vector representing the resource to be matched.

FIG. 12 illustrates evaluation of a model μ.

FIG. 13 provides a control-flow diagram for the currently disclosed dimension-reduction method.

FIG. 14 provides a control-flow diagram for the currently disclosed resource-attribute-vector scoring method.

FIG. 15 illustrates the partial derivative of an attribute vector with respect to an attribute, used in the partial optimization of attribute values.

FIG. 16 illustrates the currently disclosed partial-optimization method, using the user-selection attribute vectors an example.

FIG. 17 illustrates computing the derivative of the WOE from historical data.

FIG. 18 provides a control-flow diagram for the currently disclosed partial optimization method for attribute vectors.

FIGS. 19A-D illustrate, as one example, generating an optimal or near-optimal configuration for the resource exchange discussed above with reference to FIG. 6.

### DETAILED DESCRIPTION

The current document is directed to methods and systems that provide optimal or near-optimal resource-exchange operation through configuration and control of resource exchanges. A first subsection discusses computer hardware, computer systems, and other aspects of the electromechanical machinery controlled by currently disclosed control subsystems to provide optimal or near-optimal resource-exchange operation. In a following subsection, the currently disclosed methods and systems are discussed, in detail.

### Computer Hardware, Complex Computational Systems, and Virtualization

The terms “virtual” and “abstraction” are not, in any way, intended to mean or suggest an abstract idea or concept or some type of disembodied theory or design. Computational abstractions are tangible, physical interfaces that are implemented, ultimately, using physical computer hardware, data-storage devices, and communications systems. Virtual machines and other virtual resources are implemented in physical resources and generally include one or more additional layers of abstraction in addition to the physical resources. The term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such assertions are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. The currently disclosed optimization tools are obtained by specific control of an underlying computer system by digitally encoded computer instructions and/or by digitally encoded computer instructions combined with specific hardware modules and logic circuits. Finally, computer instructions that control computer systems when executed by processers within the computer systems may be described, at least in part, by high-level programming-language code, pseudocode, assembly code, machine instructions, control-flow diagrams, mathematical expressions, or natural-language descriptions. These are all different types of symbolic languages used to describe control logic and operation.

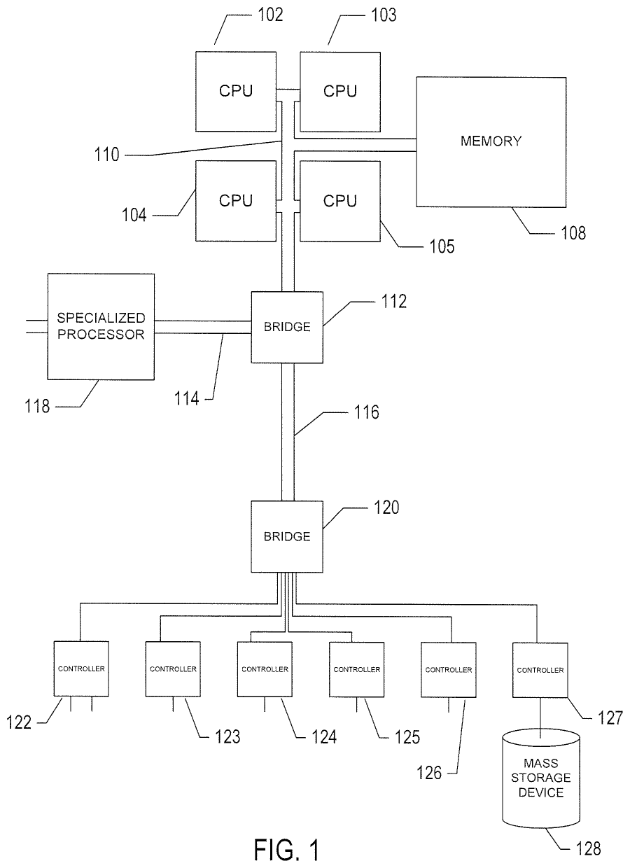

FIG. 1 provides a general architectural diagram for various types of computers. Computers that implement all or a portion of the currently disclosed optimization tools, that optimally or near optimally control and configure resource exchanges, and that implement automated and semi-automated resource exchanges may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. Such distributed computing systems provide diverse arrays of functionalities. For example, a PC or smart-phone user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

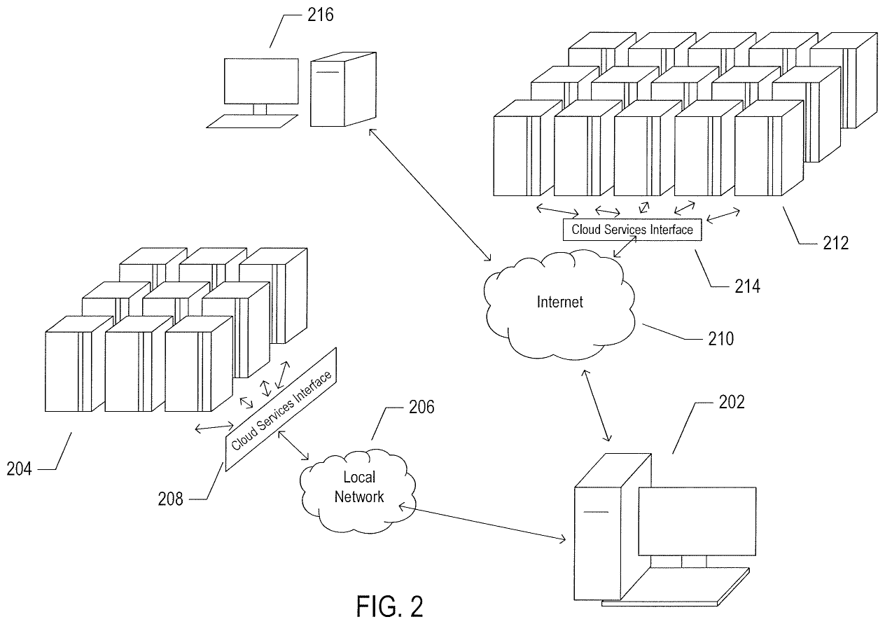

FIG. 2 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 2, a system administrator for an organization, using a PC 202, accesses the organization's private cloud 204 through a local network 206 and private-cloud interface 208 and also accesses, through the Internet 210, a public cloud 212 through a public-cloud services interface 214. The administrator can, in either the case of the private cloud 204 or public cloud 212, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 216.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

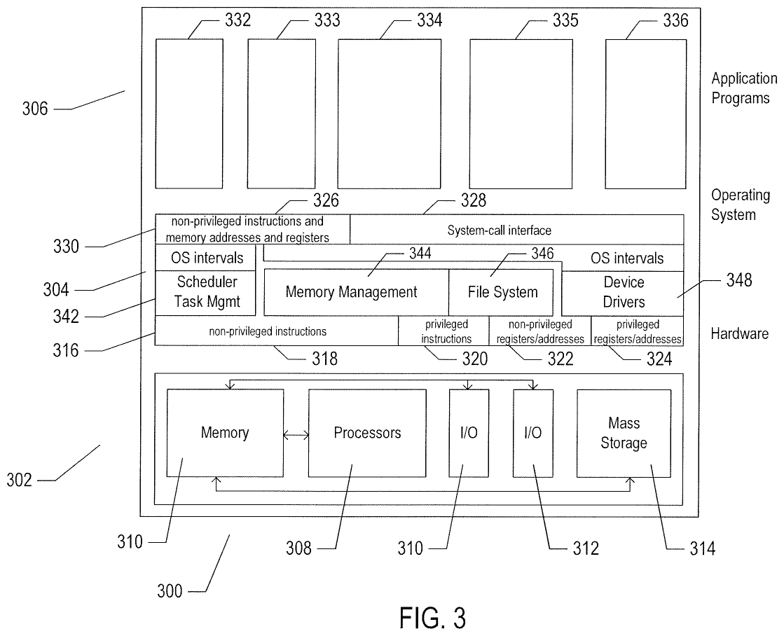

FIG. 3 illustrates generalized hardware and software components of a general-purpose computer system, such as a general-purpose computer system having an architecture similar to that shown in FIG. 1, including servers used in cloud-computing facilities. The computer system 300 is often considered to include three fundamental layers: (1) a hardware layer or level 302; (2) an operating-system layer or level 304; and (3) an application-program layer or level 306. The hardware layer 302 includes one or more processors 308, system memory 310, various different types of input-output (“I/O”) devices 310 and 312, and mass-storage devices 314. Of course, the hardware level also includes many other components, including power supplies, internal communications links and busses, specialized integrated circuits, many different types of processor-controlled or microprocessor-controlled peripheral devices and controllers, and many other components. The operating system 304 interfaces to the hardware level 302 through a low-level operating system and hardware interface 316 generally comprising a set of non-privileged computer instructions 318, a set of privileged computer instructions 320, a set of non-privileged registers and memory addresses 322, and a set of privileged registers and memory addresses 324. In general, the operating system exposes non-privileged instructions, non-privileged registers, and non-privileged memory addresses 326 and a system-call interface 328 as an operating-system interface 330 to application programs 332-336 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 342, memory management 344, a file system 346, device drivers 348, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 336 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

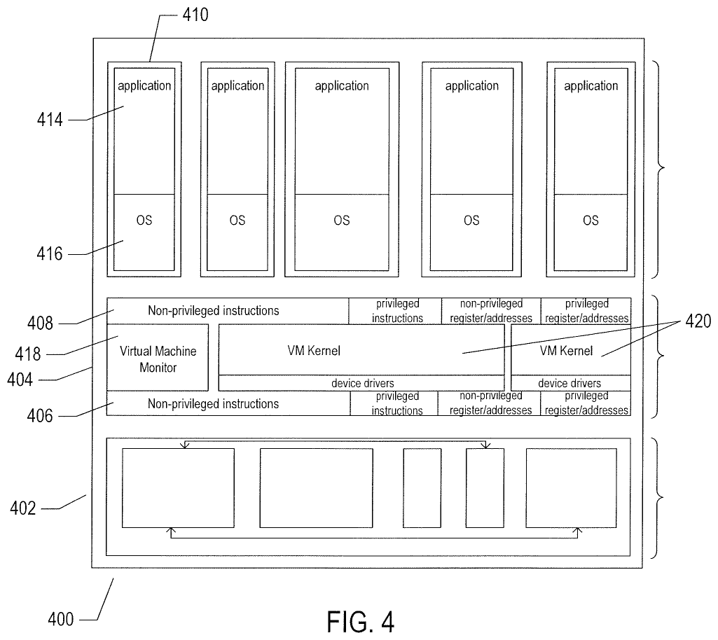

For all of these reasons, a higher level of abstraction, referred to as the “virtual machine,” has been developed and evolved to further abstract computer hardware in order to address many difficulties and challenges associated with traditional computing systems, including the compatibility issues discussed above. FIG. 4 illustrates one type of virtual machine and virtual-machine execution environment. FIG. 4 uses the same illustration conventions as used in FIG. 3. FIG. 4 shows a first type of virtualization. The computer system 400 in FIG. 4A includes the same hardware layer 402 as the hardware layer 302 shown in FIG. 3. However, rather than providing an operating system layer directly above the hardware layer, as in FIG. 3, the virtualized computing environment illustrated in FIG. 4A features a virtualization layer 404 that interfaces through a virtualization-layer/hardware-layer interface 406, equivalent to interface 316 in FIG. 3, to the hardware. The virtualization layer provides a hardware-like interface 408 to a number of virtual machines, such as virtual machine 410, executing above the virtualization layer in a virtual-machine layer 412. Each virtual machine includes one or more application programs or other higher-level computational entities packaged together with an operating system, referred to as a “guest operating system,” such as application 414 and guest operating system 416 packaged together within virtual machine 410. Each virtual machine is thus equivalent to the operating-system layer 304 and application-program layer 306 in the general-purpose computer system shown in FIG. 3. Each guest operating system within a virtual machine interfaces to the virtualization-layer interface 408 rather than to the actual hardware interface 406. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 408 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 418 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 408, the accesses result in execution of virtualization-layer code to simulate or emulate the privileged resources. The virtualization layer additionally includes a kernel module 420 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

### Currently Disclosed Methods and Systems

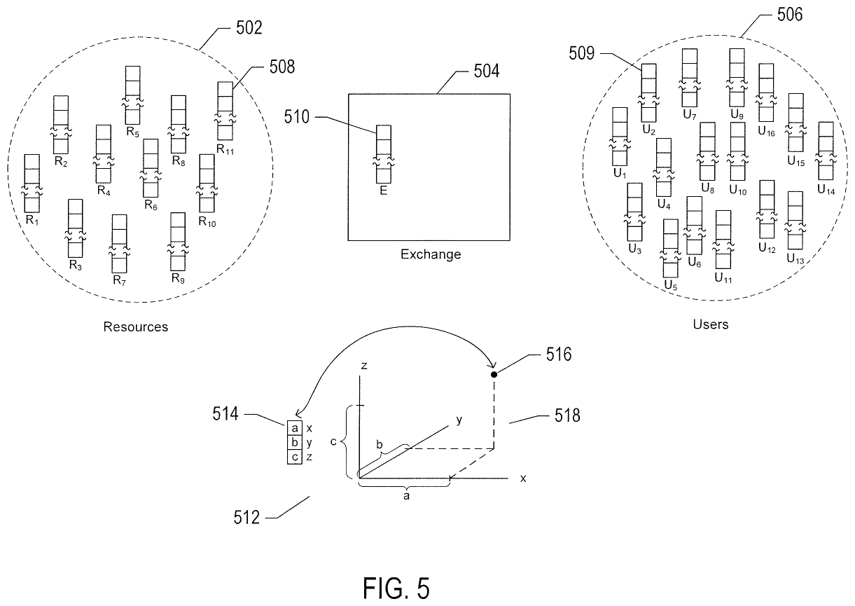

FIG. 5 illustrates a resource exchange. The resource exchange includes a set of resources 502, an automated or semi-automated exchange 504, and a set of users 506. Each resource and user and the resource exchange are characterized or represented by attribute vectors, such as resource attribute vector 508, user attribute vector 509, and an attribute vector 510 that represents the exchange. As shown in plot 512 in FIG. 5, an attribute vector 514 can be thought of as representing a point 516 in a multi-dimensional space 518 in which each dimension, and corresponding axis, represents one of the multiple dimensions. And attribute vector containing a single attribute is a one-dimensional vector representing a point along a line. An attribute vector containing two attributes is a 2-dimensional vector that represents a point in a plane. An attribute vector containing three attributes is a 3-dimensional vector that represents a point in a 3-dimensional space, or volume, as in plot 512. Attribute vectors with greater than 3 attributes represent points in hyper-dimensional spaces or volumes. The attributes represent various attributes of the resource-exchange entities. In the case of the resource-exchange attribute vector, the attributes are essentially parameters the characterize the logical organization and configuration of the resource exchange. In the case of resource and user attribute vectors, the attributes characterize the resources and users, with the attribute vector essentially encoding a description of the resource or user.

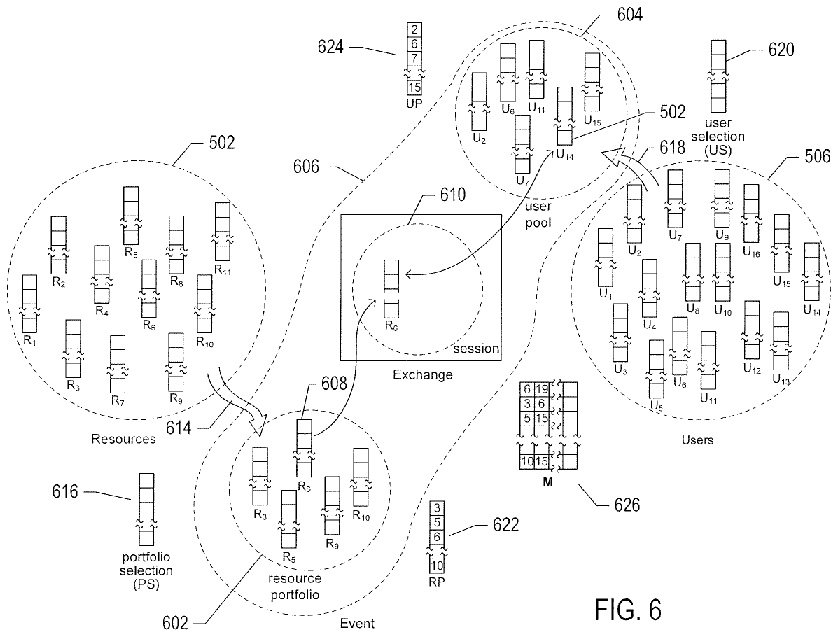

FIG. 6 illustrates additional aspects of the resource exchange discussed above with reference to FIG. 5. In general, there are a great number of resources in the set of resources 502 and a great number of users in the set of users 506. Rather than attempting to generally match users to resources in a single operation, the resource exchange instead selects a portfolio of resources 602 from the set of resources 502 and selects a user pool 604 from the set of users 506. An event, represented by the contents of the area enclosed by the dashed curve 606, is an operation in which each resource in the resource portfolio is attempted to be matched to a user in the user pool. A resource, such as resource 608, is selected from the resource portfolio for a next session 610 in which the resource selected for the session is attempted to be matched to a user, such as user 612, within the user pool. Thus, a single resource, or, in certain implementations, a set of resources that represent a subset of the resource portfolio, is attempted to be matched to a user in the user pool during each session, and, during the event that includes the session, each of the resources in the resource portfolio is attempted to be matched to a user in the user pool. The selection of resources for a resource portfolio, represented by arrow 614, is described by a portfolio-selection attribute vector 616. The selection of users for the user pool, represented by arrow 618, is described by a user-selection attribute vector 620. The attributes of the portfolio-selection and user-selection attribute vectors are parameters that control resource selection and user selection, respectively. The resources in a resource portfolio may be described by a resource-portfolio vector 622 and the users in the user pool may be described by a user-pool vector 624. In general, each completed session may be recorded as a row in a matrix M 626, where the transpose of each row in the matrix M is an attribute vector that records the session and the results of the session. The attribute vector may include some or all of the attributes of the relevant attribute vectors that characterize resources, users, resource-selection, user-selection, and other resource-exchange entities.

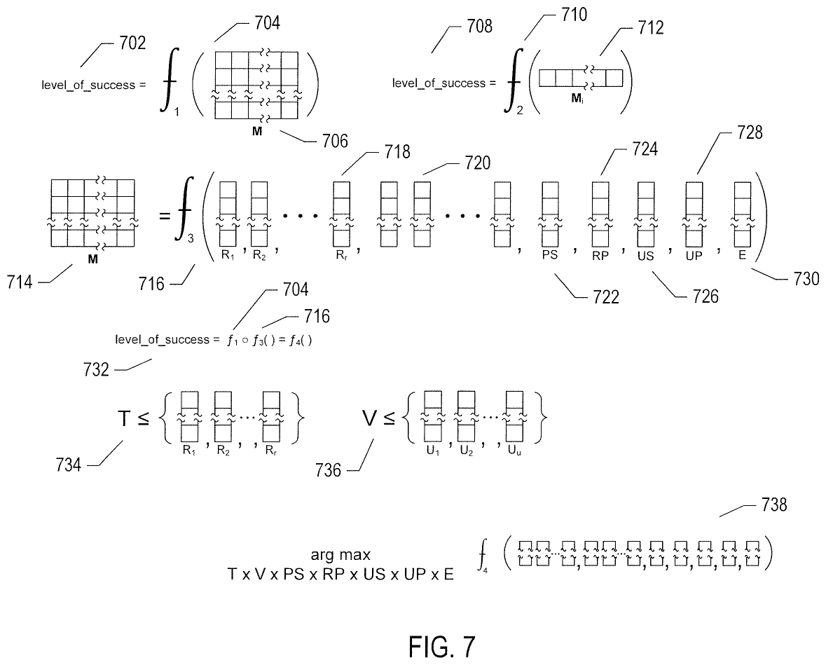

FIG. 7 illustrates the problem of optimally configuring and controlling a resource exchange. For any particular type of resource exchange, a level-of-success value or success metric 702 for a resource portfolio that is attempted to be matched to users via the resource exchange is a value returned by a function 704 of the matrix M 706 containing the recorded session results for the event in which the resource portfolio is attempted to be matched to users. Alternatively, a level-of-success value or success metric 708 may be returned by a function 710 of the results recorded for a single session 712 which, in the current example, is a row of the matrix M. The contents of the matrix M 714 can be considered to be a value returned by a function 716 of the attribute vectors for all of the resources, such as attribute vector 718, the attribute vectors for all of the users, such as attribute vector 720, the portfolio-selection attribute vector 722, the resource-portfolio vector 724, the user-selection attribute vector 726, the user-pool vector 728, and the exchange vector 730. Thus, the level-of-success value 732 can be thought of as being returned by a composition of function 704 and 716. Clearly, given that an attribute vector may contain several to several tens or more attributes, and given that there may be hundreds, thousands, or more resources and hundreds, thousands, tens of thousands, hundreds of thousands, or more users, the level of success may be a function of an enormous number of variables, since each attribute of each attribute vector can be considered to be a variable. It is generally computationally infeasible to attempt to optimize functions of so many variables. Of course, for any given event, only some subset 734 of the total number of resources may be relevant and only a subset the total number of users 736 may be relevant. However, even in that case, there are generally too many variables in the optimization problem to hope for computationally efficient solutions.

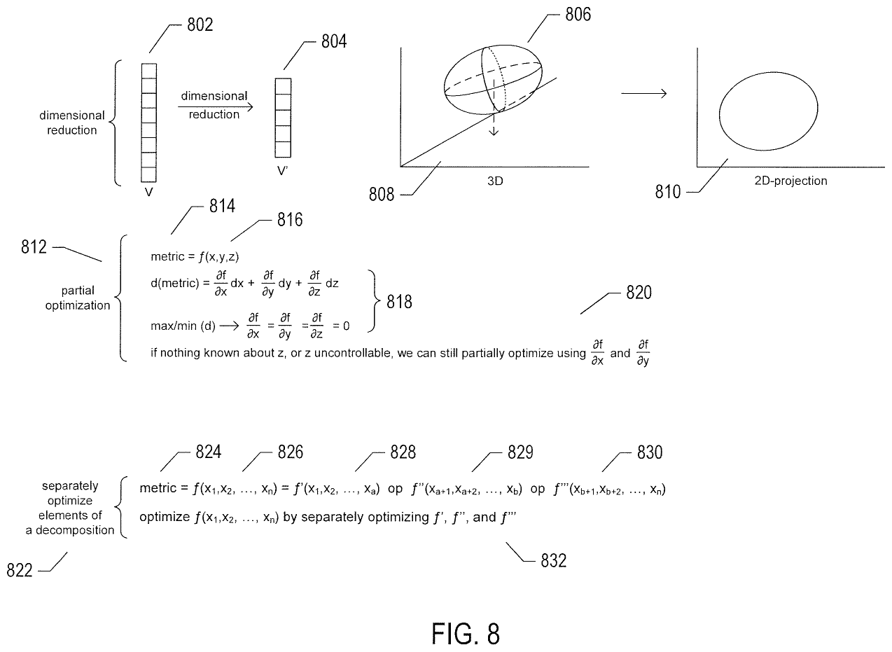

FIG. 8 illustrates various types of approaches that are used to decrease the number of variables in high-dimensional optimization problems. In one approach, referred to as “dimensional reduction,” attribute or feature vectors, such as attribute factor 802, are projected into a lower-dimensional vector space 804 by retaining only those attributes or features associated with the greatest amount of information with regard to the distribution of the points, represented by the attribute or feature vectors, within the vector space. As an example, an ellipsoid distribution of points 806 in a 3-dimensional space 808 with a relatively short minor axes may be projected as an ellipse within a 2-dimensional plane 810, preserving the major and longer of the 2 minor axes, and thus preserving much of the information of the distribution of points. Often, principal-component analysis is used for dimensional reduction. In another approach 812, where a computable metric 814 is a result of a function of many variables 816, and when information about one or more of the variables is lacking, rather than attempting a full optimization 818, a partial optimization using information about a subset of the variables can be undertaken. The partial optimization does not generally provide optimal solutions, but can identify a constrained domain in which optimal solutions lie. In a third approach 822, when the metric 824 is generated by a function of multiple variables 826, and when that function can be separated into two or more functions 828-830, each of a nonoverlapping subset of the total number of variables, optimization may be undertaken by separately and sequentially optimizing the lower-dimensional functions 832. There are, of course, many other types of generic approaches to dealing with high-dimensional optimization problems. The current document discloses new approaches relevant to optimizing resource exchanges.

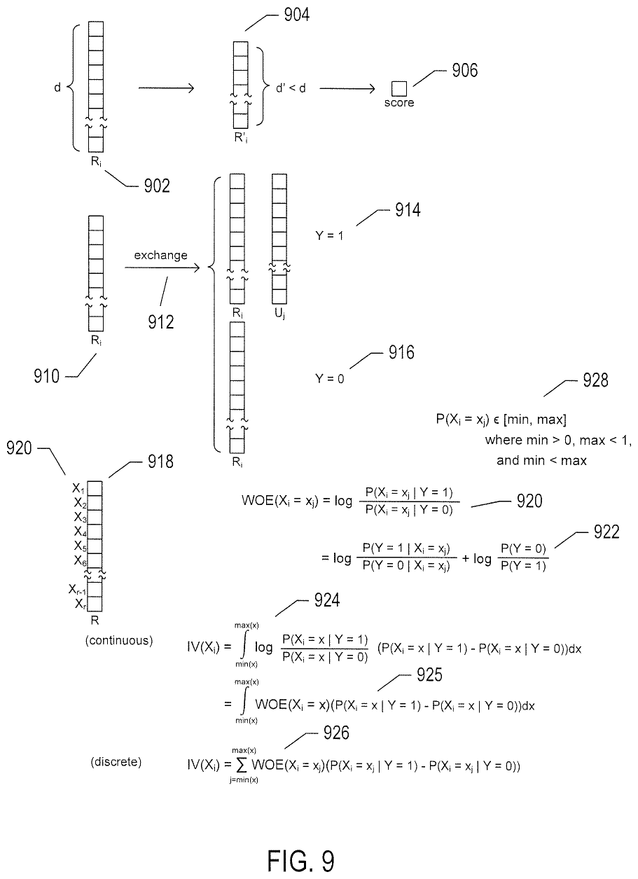

FIG. 9 illustrates generation of a weight-of-evidence value (“WOE”) and an information value (“IV”). The WOE and the IV are used both for a new type of dimensional reduction, discussed below, as well as for computing a score for resources that is representative of the ease of probability that the resource will be successfully matched to a resource user by the resource exchange. Thus, an initial resource vector of dimension d 902 is dimensionally reduced 904, using the WOE and the IV, to produce a dimensionally reduced vector of dimension d′ and a score 906 for the dimensionally reduced resource vector is generated. The outcome of an attempt to match a resource to a resource user is a binary, and represented by the binary variable Y. In other words, a given resource represented by a resource vector 910, when submitted to the resource exchange in a session 912, is either matched to a resource user, in which case Y=1 914, or fails to be matched, in which case Y=0 916. Each attribute, or dimension, of a resource vector can be considered to be a random variable. Thus, a resource vector with r attributes 918 can be considered to be a set of random variables 920 X₁, X₂, . . . , Xᵣ. A WOE can be generated for each possible value of a random variable, as represented by expressions 920 and 922. The WOE for a particular value of an attribute of a resource vector is the log of the ratio of conditional probabilities of the outcomes of the session when the resource described by the resource vector has the particular value, according to expression 920, and can alternately be viewed as the log of the ratio of the conditional probabilities of the outcome variable given that the attribute has a particular value plus the log of the ratio of the probabilities of the outcomes, according to expression 922. The IV can be computed via integration for a continuous-valued attribute according to expressions 924 and 925 and can be computed via summation, according to expression 926, for a discrete-valued attribute. In general, the probabilities for actual values in the discrete case are not 0, so that computation of the WOE is not prone to division-by-0 errors. However, in the continuous case, and in certain discrete cases, to avoid division-by-0 errors, probabilities are forced into a range of values 928 that include a minimum value greater than 0. In such cases, the expressions for the WOE and IV may include additional normalization subexpressions to account for the different sizes of the domains of attribute variables. In general, the IV it is s the sum, over each possible attribute value, of the product of the WOE for the attribute value and the difference between the conditional probabilities of the attribute value with respect to the outcome variable Y.

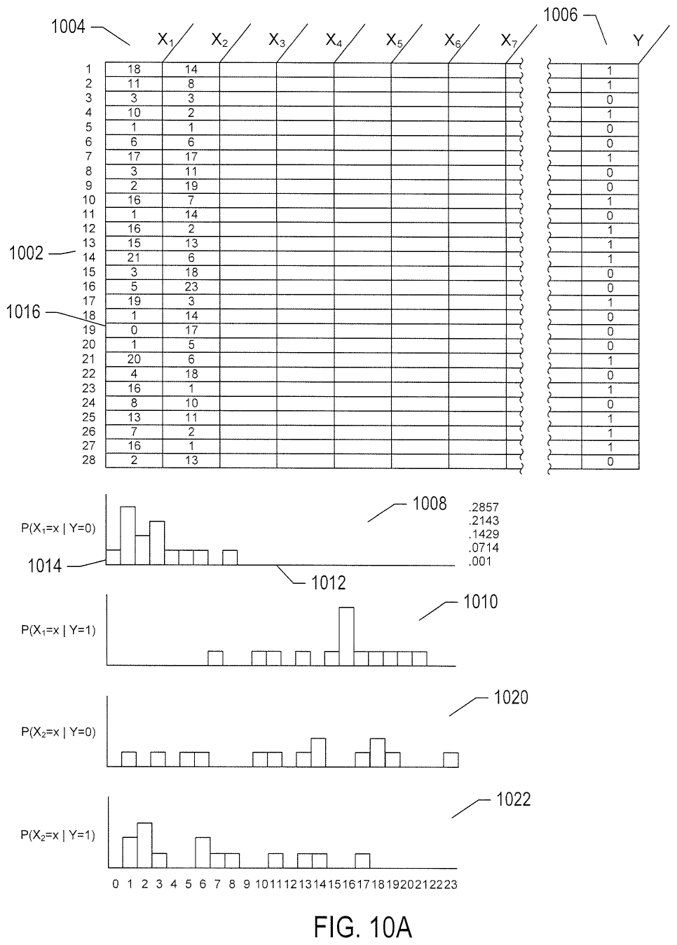

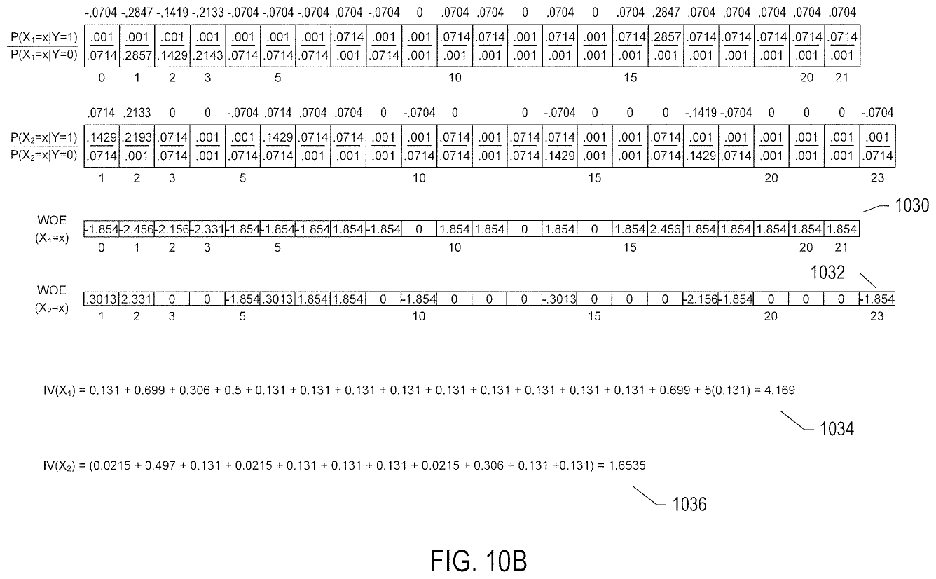

FIGS. 10A-B illustrate generation of estimated WOE and IV values for two attributes from historical data. Table 1002 represents stored historical data for resource-exchange sessions. Each row represents a session. All but the final column represent resource-attribute-vector attributes, such as column 1004, and the final column 1006 represents the binary outcome variable Y. Only values for the first two attributes are shown in the table. Plots 1008 and 1010 are histograms of the conditional probabilities of the possible values for the first attribute. Plot 1008 is a histogram of the probabilities that the first attribute will have particular values, represented by the horizontal axis 1012, when the outcome variable has the value 0 and plot 1008 is a histogram of the probabilities that the first attribute will have particular values when the outcome variable Y has the value 1. For example, histogram column 1014 has a height reflective of the probability that, when Y=0, the first attribute has the value 0. There is only a single entry 1016 in the table for this case, and therefore the height of the column is relatively low. As can be seen by comparing plots 1008 and 1010, there is no overlap in the values for the first attribute in the case that Y=0 and the values for the first attribute in the case that Y=1. Thus, the first attribute appears to faithfully discriminate between the two possible outcomes of a session, and therefore it would be expected that the IV for the first attribute would be relatively high. Plots 1020 and 1022 are histograms for the second attribute analogous to plots 1008 and 1010 for the first attribute. In this case, there is significant overlap in values in the two cases Y=1 and Y=0, so it would be expected that the IV for the second attribute would be lower than that for the first attribute. FIG. 10B illustrates computation of the WOE values over the range of attribute values for the two attributes 1030 and 1032 as well as the final computation of the IV for each attribute 1034 and 1036. As expected, the IV for the first attribute is much higher than that for the second attribute.

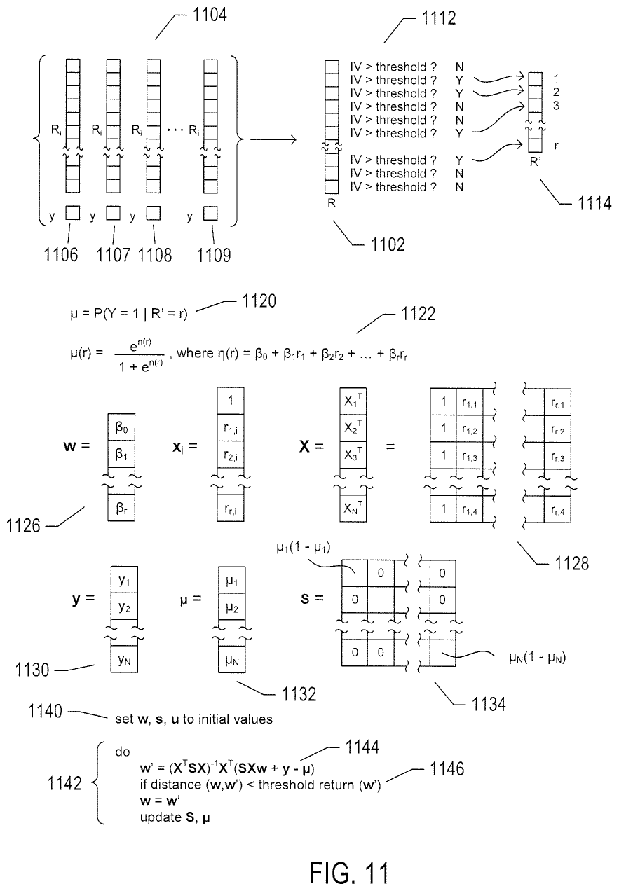

FIG. 11 illustrates IV-based dimensional reduction and generation of a model μ for the outcome of a resource-exchange system based on the attribute vector representing the resource to be matched. As shown in the top portion of FIG. 11 1102, a set of resource attribute vectors 1104 along with the session outcomes 1106-1109 are dimensionally reduced by first computing the IV for each attribute 1112 and then selecting, as the attribute for the dimensionally reduced attribute vector 1114, those attributes for which the IV is greater than a threshold value. In certain cases, the threshold may depend on a minimum desired number of attributes or on other factors. Thus, for resource-exchange optimization, dimensional reduction of attribute vectors, such as resource attribute vectors, based on WOE and IV values can be used to significantly decrease the number of variables that need to be considered during optimization. Dimensional reduction employs historical data, but the attributes selected for the dimensionally reduced vectors can be used for dimensionally reducing currently generated or received attribute vectors.

Generation of a model μ that represents the probability of a resource match given the reduced-dimension resource attribute variable for the resource to be attempted to be matched 1120 is next discussed. In one implementation, a logistic model 1122 is developed. Generation of the model μ. then becomes an exercise in finding appropriate coefficients β₀, β₁, . . . βᵣ for the logistic model. A least-squares approach to finding the coefficients using historical data is shown in pseudocode 1124 at the bottom of FIG. 11. The vector w 1126 contains the coefficients, the matrix X 1128 contains the historical resource vectors, as rows, the vector y 1130 contains the outcomes associated with the historical resource vectors, the vector μ 1132 contains the outcomes predicted by the model μ, and the matrix S 1134 is a diagonal matrix of weights. In an initial step 1140, vectors w and μ and matrix S are set to initial values. Then, in a loop 1142, new coefficients w′ are computed from matrix X, the current values of vectors w and μ, and the current value of matrix S, in step 1144, and then, when the process has converged, as determined in step 1146, the new coefficients are returned. Otherwise, vectors w and μ and matrix S are updated and a next iteration of the loop is undertaken.

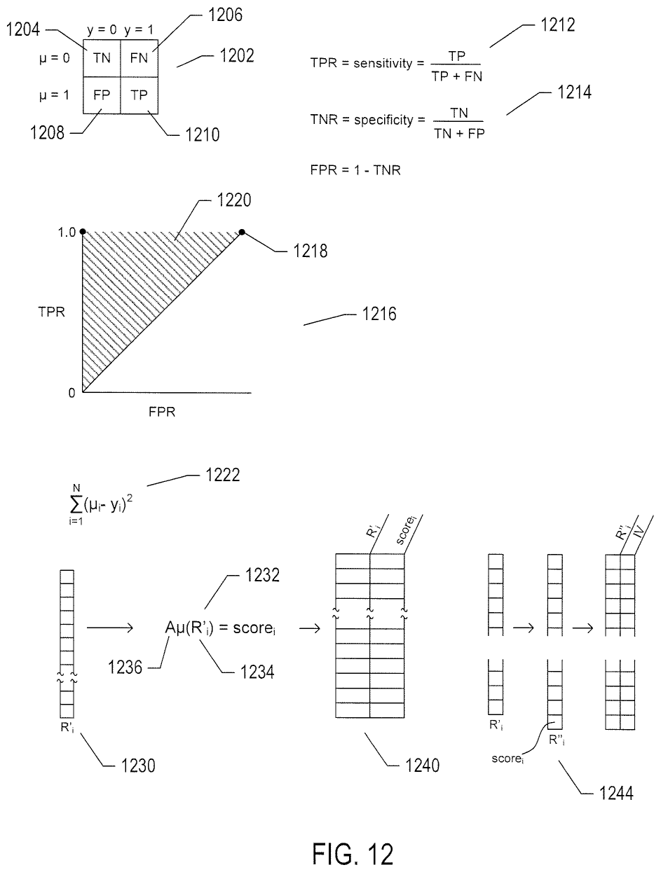

FIG. 12 illustrates evaluation of a model μ. In one approach, a confusion matrix 1202 is generated by using the model μ to generate predicted outcomes for the historical data using the actual outcomes encoded within the historical data. The number of true predicted negative outcomes TN 1204, the number of false predicted negative outcomes FN 1206, the number of false predicted positive outcomes FP 1208, and the number of true predicted positive outcomes TP 1210 are included in the confusion matrix. These values allow for computing the sensitivity 1212 and specificity 1214 for the model μ with respect to the historical data. A point corresponding to the sensitivity and specificity can be plotted in a TPR vs. FPR plot 1216. Point 1218 represents a perfect model, with maximum sensitivity and specificity. Models for which the plotted point falls in the crosshatched region 1220 of the TPR vs. FPR plot 1216 represent models with better than random predictive ability. Model parameters can be varied to generate curves in the TPR vs. FPR plot to facilitate additional optimization. Alternatively, various metrics, such as the sum of the squared distances between the predicted outcomes and actual outcomes 1222, can be used to evaluate the quality of the model. Many other types of model-validation methods can also be employed. Once an acceptable model has been generated, each attribute vector corresponding to a resource that is to be submitted to the resource exchange 1230 can be associated with a score 1232 generated by multiplying the probability for a favorable outcome, returned by the model 1234 for the resource attribute vector corresponding to the resource, by a coefficient 1236. Thus, each resource in a resource portfolio can be associated with the score, as represented by a table 1240 in which each row represents a resource and the score generated for the resource. Finally, as an additional validation of the scores generated for resources, the score values can be added to resource attribute vectors 1244 as an additional attribute and the above-described methods can be used to generate an IV for this new attribute. When the IV values for the new score attributes are greater than a threshold value, or when the average value for the new score attributes are greater than a threshold value, then the score may be considered to be reflective of the likelihood that the resource will be successively matched to a resource user during a session.

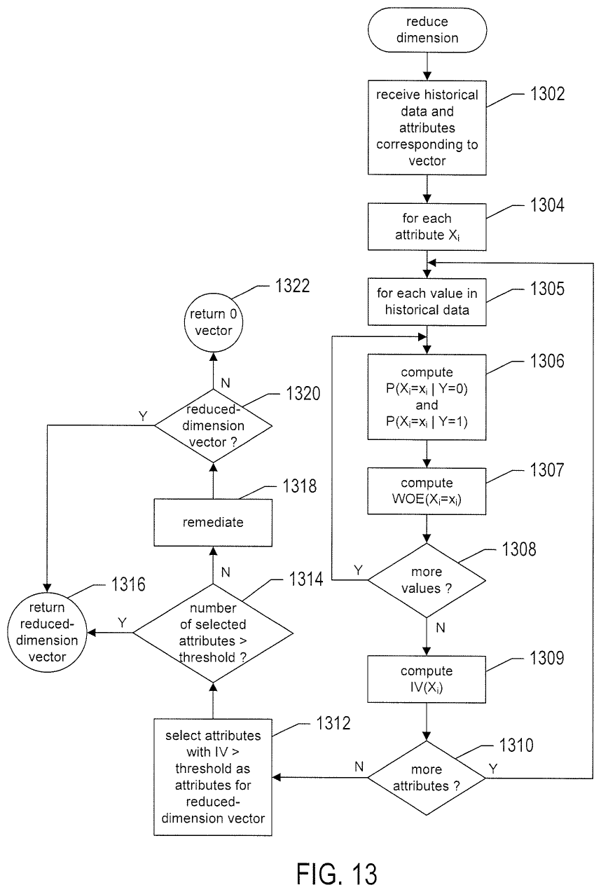

FIG. 13 provides a control-flow diagram for the currently disclosed dimension-reduction method. In step 1302, historical data and an indication of the attributes within the historical data corresponding to an attribute vector are received. In the outer for-loop of steps 1304-1310, each attribute of the attribute vector is considered. In the inner for-loop of steps 1305-1308, WOE values are computed for each value of the currently considered attribute. Then, in step 1309, the IV value for the attribute is computed. In step 1312, those attributes with IV values greater than a threshold value are selected as the attributes to retain in the dimensionally reduced vector. When the number of retained attributes is greater than a threshold value, as determined in step 1314, these attributes are returned as the attributes for the reduced-dimensional vector in step 1316. Otherwise, in step 1318, some type of remediation is carried out, such as lowering the threshold. If the remediation succeeds, as determined in step 1320, the attributes for the dimensionally reduced vector are returned in step 1316. Otherwise an error is returned, such as a 0 vector, in step 1322.

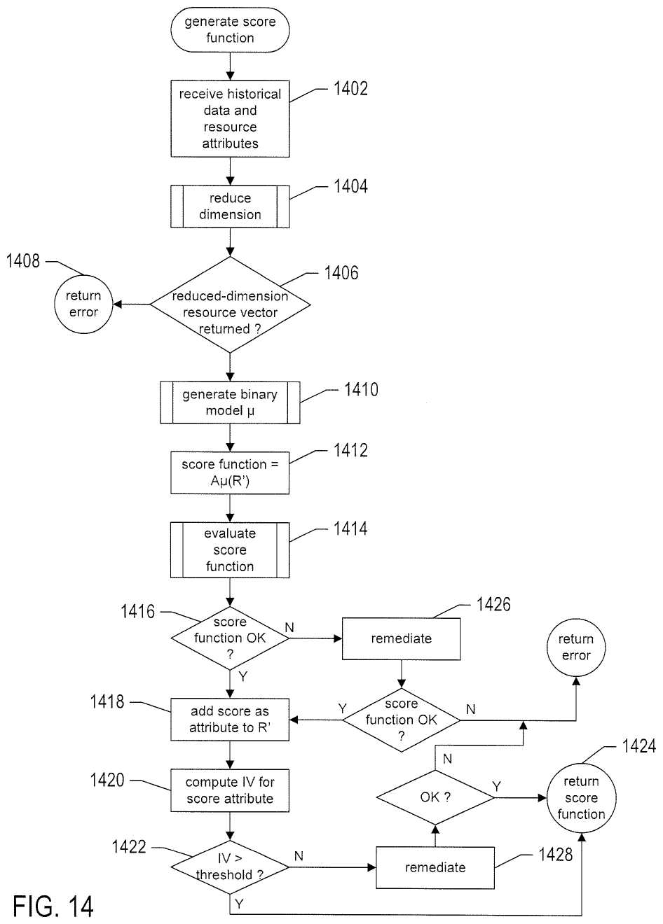

FIG. 14 provides a control-flow diagram for the currently disclosed resource-attribute-vector scoring method. In step 1402, historical data that includes resource vectors and an indication of the resource-vector attributes is received. In step 1404, the above-discussed dimension-reduction method is employed to generate reduced-dimension resource vectors. If dimensional reduction fails, as determined in step 1406, then an error is returned, in step 1408. Otherwise, a binary model μ is generated using the historical data in step 1410, as discussed above with reference to FIG. 11. A score function is then generated in step 1412, as discussed above with reference to FIG. 11. In step 1414, the model is evaluated, as discussed above with reference to FIG. 12. When the score function is acceptable, as determined in step 1416, then the score generated for each dimensionally reduced resource vector is added as an additional attribute, in step 1418, as discussed above with reference to FIG. 12, and the IV values for the score attributes are computed in step 1420. When these IDs are acceptable, as determined in step 1422, the score function is returned in step 1424. When the score function is not acceptable, as determined in step 1416, then some type of remediation is undertaken, in step 1426. Similarly, remediation is undertaken, in step 1428, when the IV values for the score attributes are not acceptable.

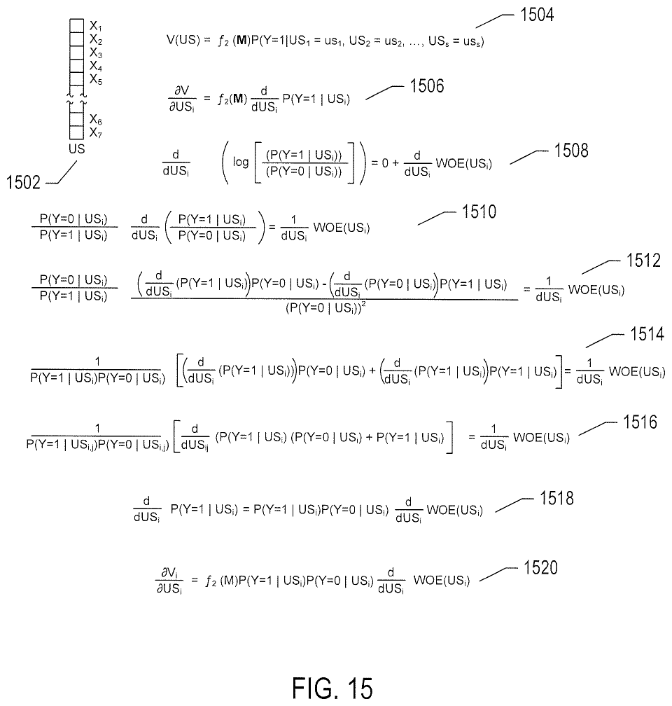

The currently disclosed methods additionally include a partial optimization method for optimizing the values of an attribute vector, such as the user-selection attribute vector (620 in FIG. 6). FIG. 15 illustrates the partial derivative of an attribute vector with respect to an attribute, used in the partial optimization of attribute values. Again, as indicated by the annotations of the user-selection vector 1502 in FIG. 15, each attribute of the vector can be considered to be a random variable. As discussed above with reference to FIG. 7, a level-of-success value, or metric, can be computed from historical data. A value metric can be generated by a value function V for an attribute vector as the product of the metric and the probability of a positive outcome when the attributes of the attribute vector have particular values 1504. The partial derivative of this value function with respect to a particular attribute 1506 of the attribute vector can be used, as discussed below, to find a partially optimized value for the attribute. To compute this partial derivative, the derivative of both sides of the expression 922 in FIG. 9 is taken 1508. Using the well-known form for the derivative of the log of a function produces expression 1510. Using the well-known form for the derivative of a ratio of functions, expression 1512 is obtained. Because the sum of the conditional probabilities of the outcome variable Y with respect to the attribute is 1.0, the derivative of the conditional probability of a positive outcome, given a particular value of the attribute, is equal to the negative of the derivative of the conditional probability of a negative outcome, given a particular value of the attribute, which leads to expression 1514. Simplification of this expression leads to expression 1516 and then to expression 1518. Thus, the desired partial derivative of the value function with respect to an attribute in attribute vector 1520 is obtained. This function is the product of the level-of-success value, or metric, the conditional probabilities of the outcome with respect to the attribute having a particular value, and the derivative of the WOE with respect to the attribute.

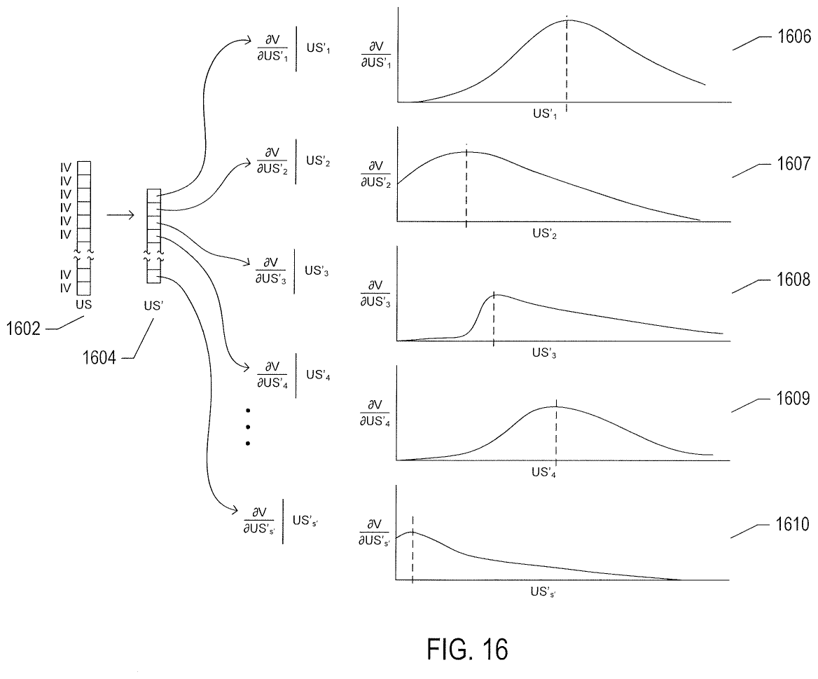

FIG. 16 illustrates the currently disclosed partial-optimization method using the user-selection attribute vector as an example. IV values for the attributes of the user-selection attribute vector are first computed 1602 in order to generate a dimensionally reduced user-selection attribute vector 1604. Then, using the partial derivative of the value function with respect to each attribute, plots of the partial derivative for the various different attribute values 1606-1610 can be obtained using historical data. Points in the plotted curves at which the partial derivative has the value 0 then represent local minima and maximum, and since, in general, such curves include one or a few local maxima, the attribute values corresponding to these few local maxima are selected as candidates for partially optimized values for the attribute. In most cases, there is a clear global maximum which is selected as the partially optimized value for the attribute.

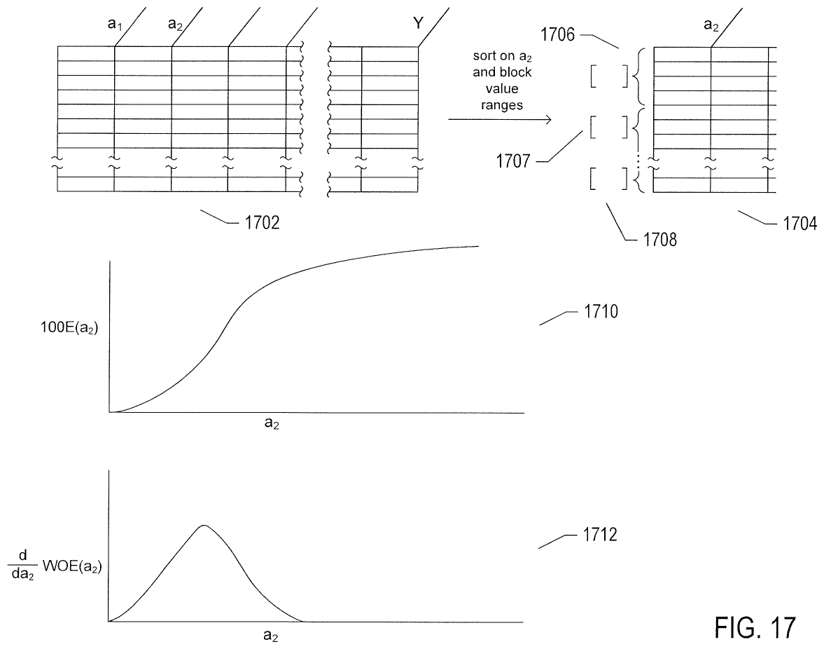

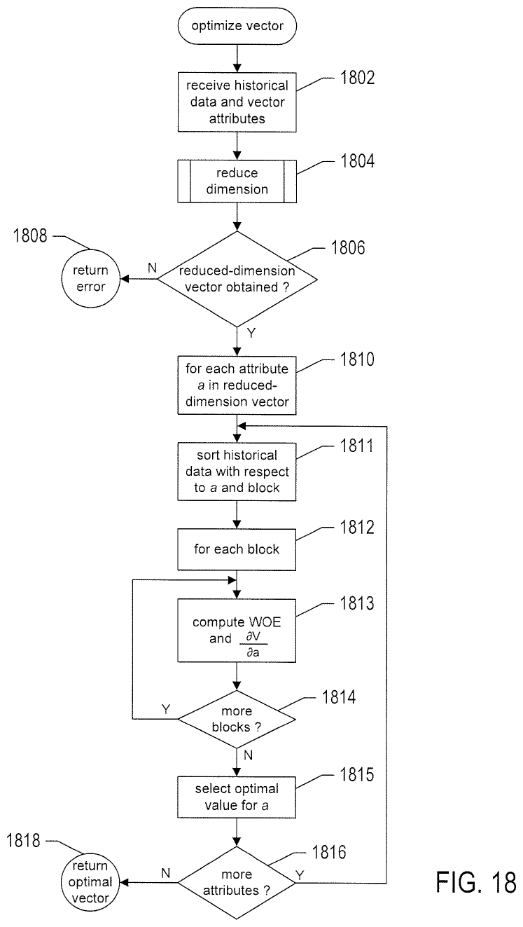

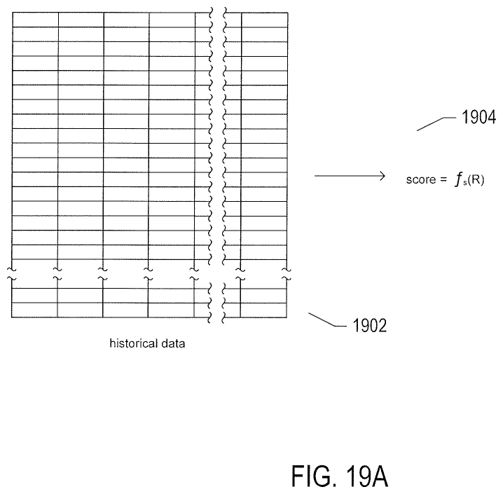

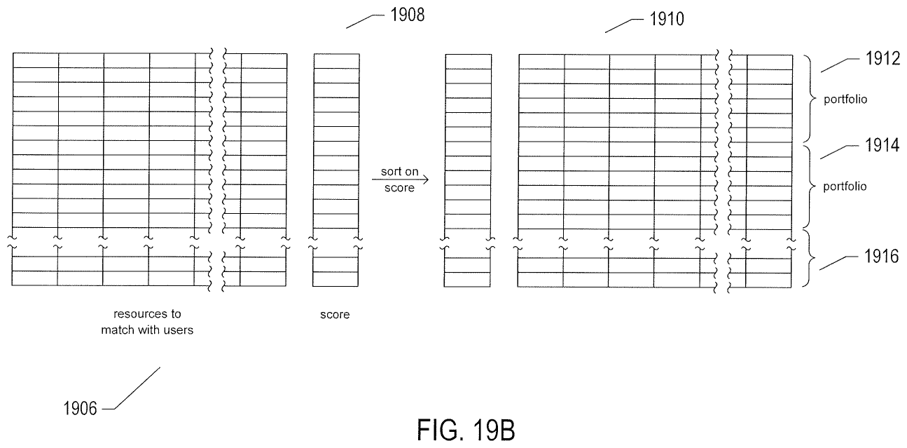

FIG. 17 illustrates computing the derivative of the WOE from historical data. Table 1702 represents the historical data, in which columns correspond to attributes. Using the currently discussed partial optimization method on a selected attribute, for this example attribute a₂, the historical data can be sorted with respect to this attribute 1704 and then blocked or binned into blocks 1706, 1707, and 1708 of historical-data entries with similar values for the attribute. An average WOE is then computed for each block and plotted as a plot of WOE vs. the value of the attribute 1710. A plot 1712 of the slope of the curve in plot 1710 is then a plot of the derivative of the WOE with respect to different values of the attribute. The derivative of the WOE at a particular value of the attribute and the found by intercepting a vertical line through the attribute value with the curve in plot 1712 or, alternatively, by computing the slope of the curve in plot 1710 corresponding to the attribute value.

FIG. 18 provides a control-flow diagram for the currently disclosed partial optimization method for attribute vectors. In step 1802, historical data and indications of the attributes of the vector are received. In step 1804, the above-discussed dimensional reduction is carried out to dimensionally reduced the attribute vector. When the dimensional reduction fails, as determined in step 1806, an error is returned in step 1808. Otherwise, in the outer for-loop of steps 1810-1816, each attribute in the reduced-dimensional vector is considered. For each attribute, the historical data is sorted with respect to the attribute and blocks, as discussed above with reference to FIG. 17. In the inner for-loop of steps 1812-1814, the WOE and the partial derivative of the value function with respect to the attribute value represented by the block are computed. Finally, in step 1815, an optimal value for the currently considered attribute is selected, as discussed above with reference to FIG. 16. Following completion of the outer for-loop of steps 1810-1816, the optimal values for the attributes are returned in step 1818.

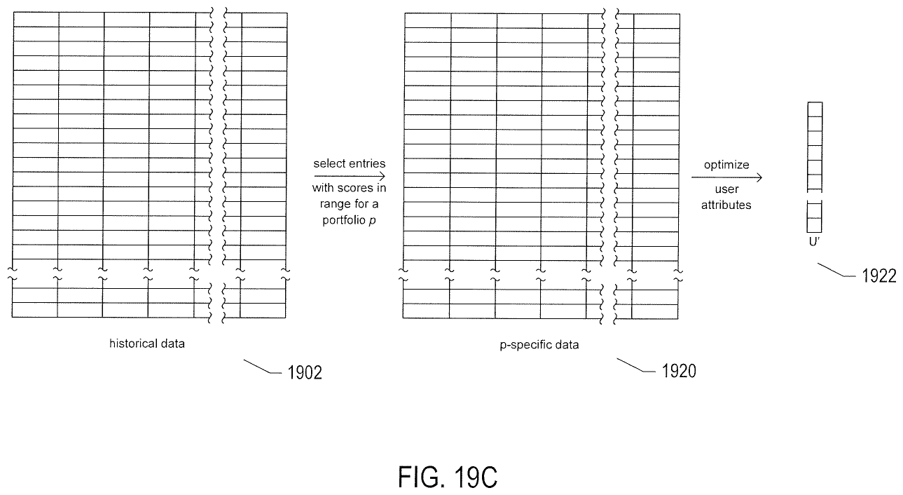

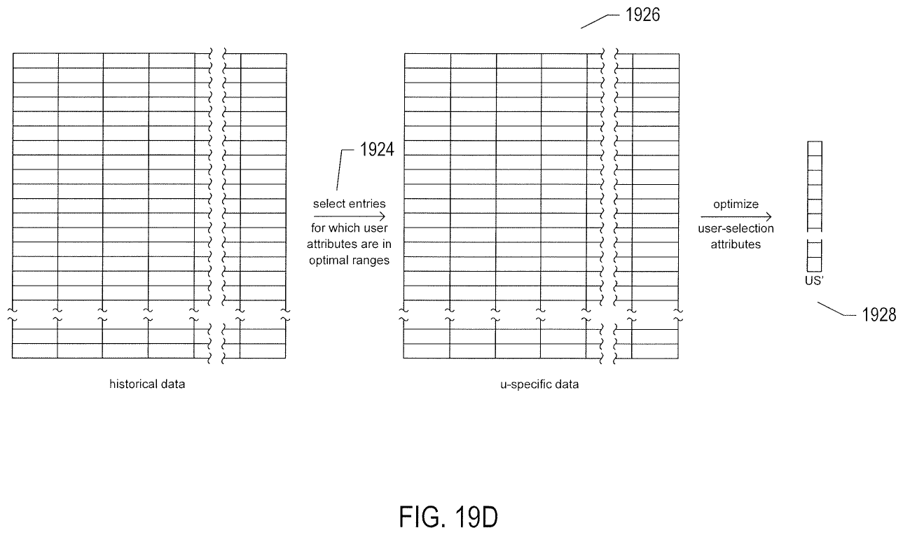

The above-disclosed methods provide fundamental optimization tools for optimizing resource exchanges. FIGS. 19A-D illustrate, as one example, generating an optimal or near-optimal configuration for the resource exchange discussed above with reference to FIG. 6. In this approach, the optimal configuration is obtained by selecting resource portfolios based on scores obtained by the above-discussed scoring method and optimizing the parameters for user selection represented by the user-selection vector 620. In this example, a subset of resources is given, as a result of which all of the resources outside of the given subset need not be considered. Similarly, rather than considering all of the potential users, the user-selection parameters are optimized in order to attempt to select an optimal set of users for the user pool. In this example, the near-optimal configuration is carried out for an entire resource portfolio. In alternative schemes, additional optimization can be carried out for each session. Many other types of optimization schemes based on the above-discussed optimization tools are also possible. Note that the example optimization scheme uses the various types of approaches discussed above with reference to FIG. 8.

FIG. 19A shows a first step in the example resource-exchange-configuration optimization. In this step, the historical data 1902 is used to obtain a scoring function for resource attribute vectors 1904 by the above-discussed scoring method. As shown in FIG. 19B, a given subset of the resources for which matches to users are desired 1906 are assigned scores 1908 using the scoring function determined from the historical data. The given subset of resources is then sorted 1910 by score and blocks of similarly scored resources 1912, 1914, and 1916 are selected as resource portfolios. In this scheme, it is assumed that similarly-scored resources may have characteristics that can facilitate resource-exchange optimization with respect to the similarly-scored resources. Next, as shown in FIG. 19C, a subset 1920 of the historical data 1902 is selected. The selection criteria is to select entries with resource-vector scores in the same range as the resource scores for a particular resource portfolio p. Then, the partial optimization method discussed above with reference to FIGS. 15-18 is used to optimize values for the user attribute vector 1922. In other words, the example optimization scheme determines the characteristics for the users most likely to be matched to the resources in resource portfolio p. Finally, as shown in FIG. 19D, the optimized values for the user attribute vector are employed to select entries from the historical data 1924 to produce a subset 1926 of the historical data that contains entries representative of the optimal users. Then, the partial optimization method discussed above with reference to FIGS. 15-18 is employed to obtain optimal values for the user-selection vector 1928 based on historical-data subset 1926. These values then become, along with the selected portfolio, the configuration parameters for the resource exchange most likely to optimize the value returned by the value function.

Although the present invention has been described in terms of particular embodiments, it is not intended that the invention be limited to these embodiments. Modification within the spirit of the invention will be apparent to those skilled in the art. For example, any of a variety of different implementations of the currently disclosed methods and systems can be obtained by varying any of many different design and implementation parameters, including modular organization, programming language, underlying operating system, control structures, data structures, and other such design and implementation parameters. As discussed above, many different resource-exchange-configuration and resource-exchange-control optimization schemes can be developed based on the above-disclosed methods and systems that represent optimization tools for optimizing resource exchanges. The particular optimization schemes selected in any particular situation may depend on the amount of available historical data and the quality of dimension reduction and partial optimizations of parameter vectors.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A resource-exchange comprising:
one or more computer systems, each having one or more processors, one or more memories, and one or more mass-storage devices; and
computer instructions which, when executed by one or more of the one or more processors, control the one or more computer systems to
configure the resource exchange by
selecting a resource portfolio from a given subset of resources based on resource scores computed using a model-based scoring function, and
determining user-selection parameters for selecting a pool of users by partially optimizing values for a set of user-selection attributes using historical data, and
match the portfolio of resources to users during a resource-exchange event carried out by the configured resource exchange.
